(19) United States
(12) Patent Application Publication
(10) Pub. No.: US 2026/0319266 A1
(43) Pub. Date: Oct. 15, 2026

(54) REPLACEABLE LENS EYEGLASSES DEVICE

(71) Applicant: Michael Mougeot, Byron, CA (US)

(72) Inventor: Michael Mougeot, Byron, CA (US)

(21) Appl. No.: 19/174,648

(22) Filed: Apr. 9, 2025

(51) Int. Cl. G02C 1/06; G02C 5/20

(52) U.S. Cl. CPC G02C 1/06; G02C 5/20; G02C 2200/06; G02C 2200/08

(57) ABSTRACT

A replaceable lens eyeglasses device includes a pair of eyeglasses that has a pair of eyewires and a pair of temples. A pair of first clamps is each movably integrated into a respective eyewire of the eyeglasses and a pair of second clamps is each movably integrated into a respective eyewire of the eyeglasses. Each of the first clamps and each of the second clamps compresses against a respective lens that is inserted into the respective eyewire for retaining the respective lens in the respective eyewire. A pair of handles is each coupled to a respective second clamp to urge the pair of second clamps inwardly on the respective eyewire to make room for the lens.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to eyeglasses devices and more particularly pertains to a new eyeglasses device for re-using lenses from broken or damaged eyeglasses. The devices includes a pair of eyeglasses and a pair of first clamps movably integrated into a respective eyewire of the eyeglasses and a pair of second clamps movably integrated into a respective eyewire. The first clamps and the second clamps are biased to compress against the lens when the lens is positioned in the respective eyewire to retain the lens in the respective eyewire.

### (2) Description of Related Art Including Information Disclosed Under 37 CFR 1.97 and 1.98

The prior art relates to eyeglasses devices including: a universal eyeglass frame device that includes a rigid bar with crenellations and a pair of lens holders that are removably attachable to respective crenellations; a modular eyeglasses device that includes a single lens and a pair of temples that are removably attachable to the single lens and a nose guard that is removably attachable to the single lens; a variety of wireframe eyeglasses devices that each at least includes a pair of wireframed eyeglasses and a retention element movably integrated into the wireframed eyeglasses for retaining lenses in the wireframed eyeglasses. In no instance does the prior art disclose a replaceable lens eyeglasses device that includes a pair of eyeglasses and a pair of first clamps movably integrated into a respective eyewire of the eyeglasses and a pair of second clamps movably integrated into a respective eyewire of the eyeglasses which each compress against a lens to retain the lens in the respective eyewire.

### (h) BRIEF SUMMARY OF THE INVENTION

An embodiment of the disclosure meets the needs presented above by generally comprising a pair of eyeglasses that has a pair of eyewires and a pair of temples. A pair of first clamps is each movably integrated into a respective eyewire of the eyeglasses and a pair of second clamps is each movably integrated into a respective eyewire of the eyeglasses. Each of the first clamps and each of the second clamps compresses against a respective lens that is inserted into the respective eyewire for retaining the respective lens in the respective eyewire. A pair of handles is each coupled to a respective second clamp to urge the pair of second clamps inwardly on the respective eyewire to make room for the lens.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front exploded perspective view of a replaceable lens eyeglasses device according to an embodiment of the disclosure.

FIG. 2 is a front perspective view of an embodiment of the disclosure.

FIG. 3 is a front view of an embodiment of the disclosure.

FIG. 4 is a magnified phantom detail view taken from circle 4 of FIG. 3 of an embodiment of the disclosure.

FIG. 5 is a magnified phantom detail view taken from circle 5 of FIG. 1 of an embodiment of the disclosure.

FIG. 6 is a perspective in-use view of an embodiment of the disclosure.

### (j) DETAILED DESCRIPTION OF THE INVENTION

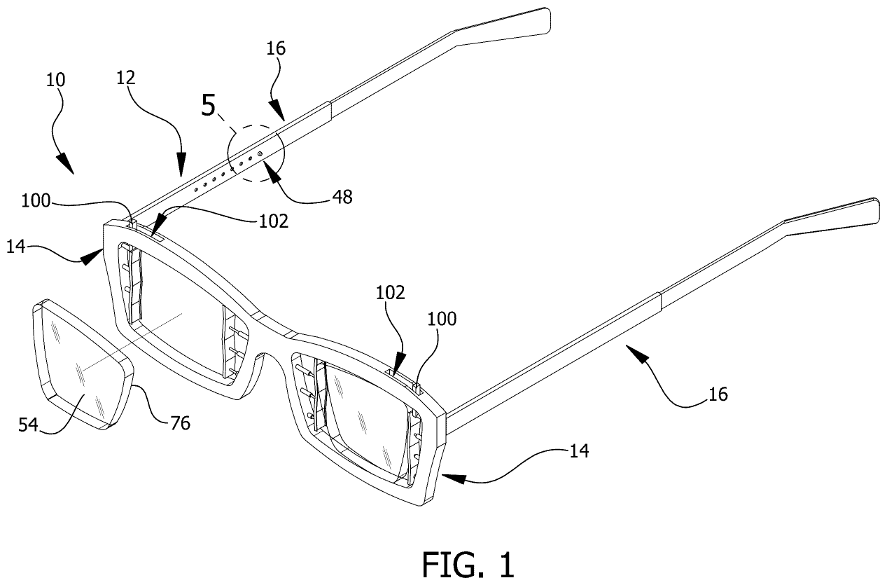

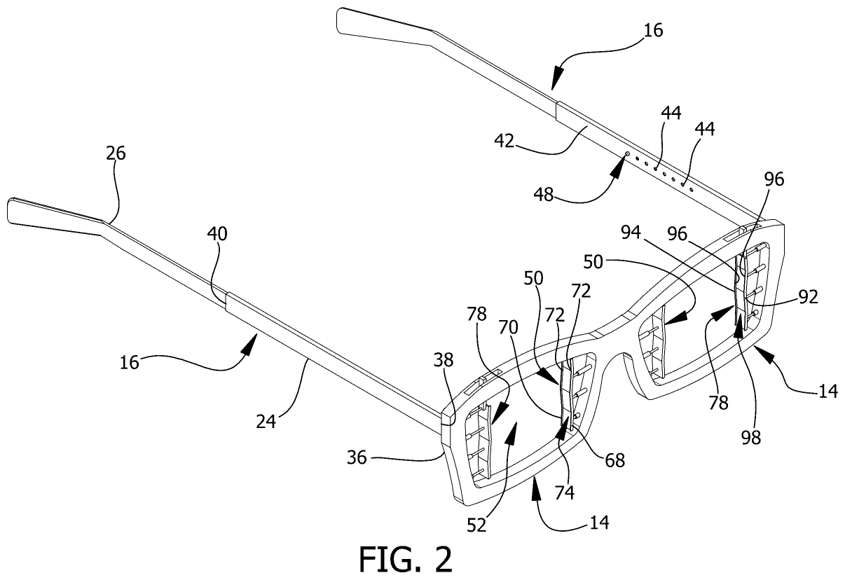

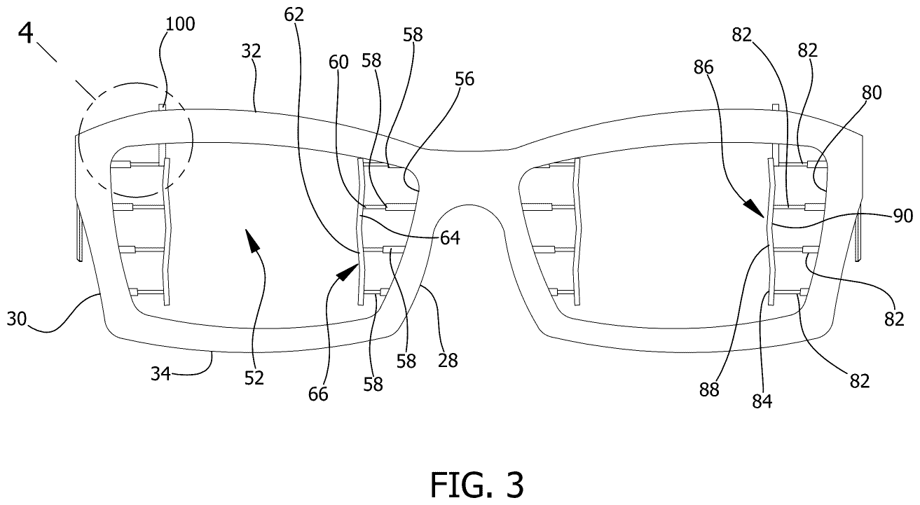

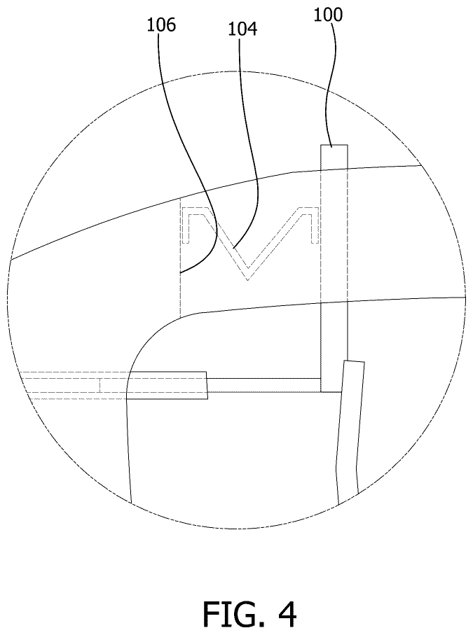

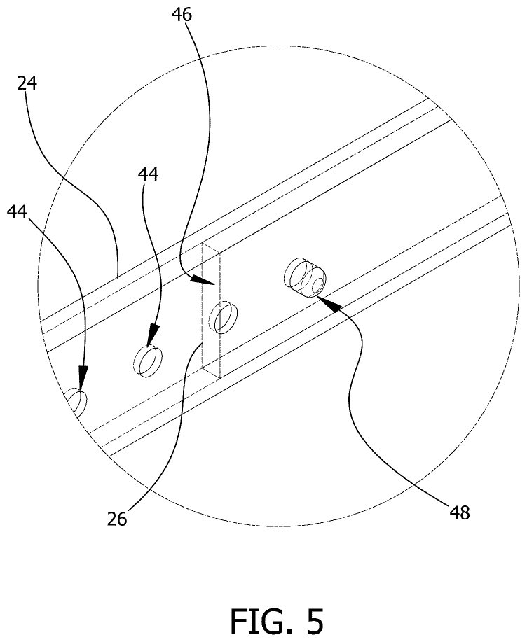

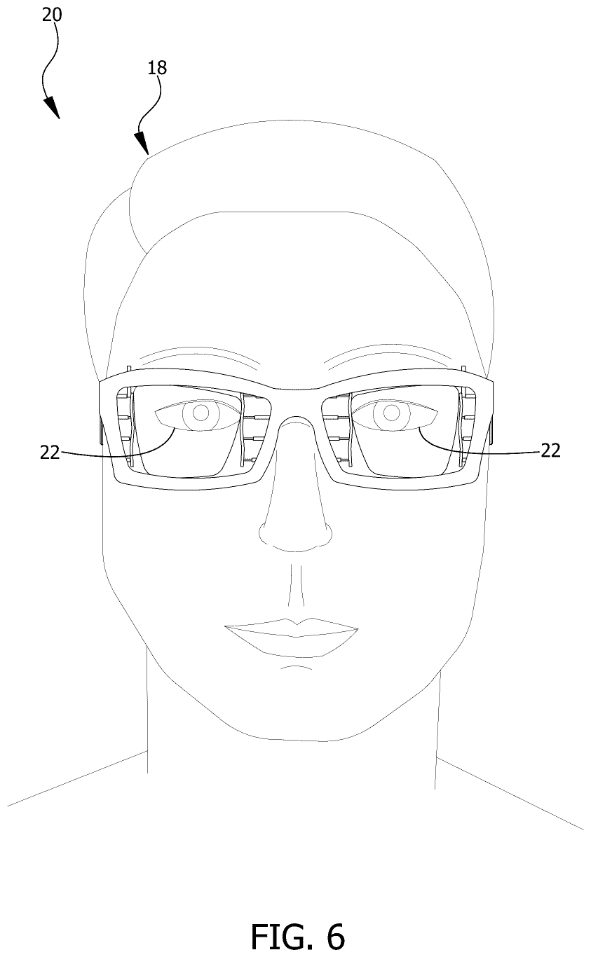

With reference now to the drawings, and in particular to FIGS. 1 through 6 thereof, a new eyeglasses device embodying the principles and concepts of an embodiment of the disclosure and generally designated by the reference numeral 10 will be described.

As best illustrated in FIGS. 1 through 6, the replaceable lens eyeglasses device 10 generally comprises a pair of eyeglasses 12 that has a pair of eyewires 14 and a pair of temples 16. The pair of eyeglasses 12 can be worn on a head 18 of a user 20 having each eyewire 14 of the pair of eyewires 14 being positioned in front of a respective eye 22 of the user 20. Each temple 16 of the pair of temples 16 comprises a first portion 24 which slidably receives a second portion 26 such that each temple 16 of the pair of temples 16 has a telescopically adjustable length to fit a variety of sizes of users. Each eyewire 14 of the pair of eyewires 14 comprises a first outward member 28 and a second outward member 30 which each extend between a top member 32 and a bottom member 34. Furthermore, the second outward member 30 of each eyewire 14 of the pair of eyewires 14 has a rear surface 36.

The first portion 24 of each temple 16 of the pair of temples 16 has a coupled end 38 and a free end 40; the coupled end 38 of the first portion 24 of each temple 16 of the pair of temples 16 is hingedly coupled to the rear surface 36 of a the second outward member 30 of a respective eyewire 14. The free end 40 of the first portion 24 of each temple 16 of the pair of temples 16 is open. Each temple 16 of the pair of temples 16 has an inwardly facing side 42 extending between the coupled end 38 and the free end 40. Additionally, each temple 16 of the pair of temples 16 has a plurality of holes 44 extending through the inwardly facing side 42. The plurality of holes 44 in a respective temple 16 is centrally located between the coupled end 38 and the free end 40 of the respective temple 16. Furthermore, the plurality of holes 44 in a respective temple 16 is evenly spaced apart from each other and is distributed along a line extending between the coupled end 38 of the respective temple 16 and the free end 40 of the respective temple 16. The second portion 26 of each temple 16 of the pair of temples 16 has a front end 46 and the free end 40 of the first portion 24 of a respective temple 16 insertably receives the front end 46 of the second portion 26 of the respective temple 16.

A pair of locks 48 is provided and each lock 48 of the pair of locks 48 is movably disposed on the second portion 26 of a respective temple 16. Each lock 48 of the pair of locks 48 is biased to extend away from the second portion 26 of the respective temple 16 and each lock 48 of the pair of locks 48 is urgeable toward the second portion 26 of the respective temple 16. Furthermore, each lock 48 of the pair of locks 48 extends through a respective one of the plurality of holes 44 in the inwardly facing side 42 of the first portion 24 of a respective temple 16 for retaining the second portion 26 of the respective temple 16 at a desired length of extension from the first portion 24 of the respective temple 16. In addition, each lock 48 of the pair of locks 48 may include a ball and a spring which biases the ball away from the first portion 24 of the respective temple 16.

A pair of first clamps 50 is each movably integrated into a respective eyewire 14 of the eyeglasses 12 and each first clamp 50 of the pair of first clamps 50 is compressible inwardly on the respective eyewire 14. Additionally, each first clamp 50 of the pair of first clamps 50 is located in a lens opening 52 defined by the respective eyewire 14 such that each first clamp 50 of the pair of first clamps 50 can compress against a respective lens 54 that is inserted into the lens opening 52 defined by the respective eyewire 14. The first outward member 28 of each eyewire 14 of the pair of eyewires 14 has an inwardly facing surface 56 and each first clamp 50 of the pair of first clamps 50 is disposed on the inwardly facing surface 56 of the first outward member 28 of a respective eyewire 14.

Each the each first clamp 50 of the pair of first clamps 50 comprises a plurality of first biasing members 58 which is each coupled to and extends laterally away from the inwardly facing surface 56 of the first outward member 28 of a respective eyewire 14. The plurality of first biasing members 58 is evenly spaced apart from each other and is distributed between the top member 32 and the bottom member 34 of the respective eyewire 14. Additionally, each first biasing member 58 of the plurality of first biasing members 58 has a distal end 60 with respect to the inwardly facing surface 56. Each first biasing member 58 of the plurality of first biasing members 58 is biased to elongate between the inwardly facing surface 56 and the distal end 60. Conversely, each first biasing member 58 of the plurality of first biasing members 58 is compressible between the distal end 60 and the inwardly facing surface 56.

Each first clamp 50 of the pair of first clamps 50 includes a first panel 62 that has a first lateral surface 64 and a second lateral surface 66 and a front edge 68 and a back edge 70. The distal end 60 of each first biasing member 58 of the plurality of first biasing members 58 is coupled to the first lateral surface 64. Additionally, the first panel 62 associated with a respective first clamp 50 is oriented to extend partially between the top member 32 and the bottom member 34 of the respective eyewire 14. The first panel 62 has a pair of ridges 72 each extending away from the first lateral surface 64 and each ridge 72 of the pair of ridges 72 is aligned with and is coextensive with a respective one of the front edge 68 and the back edge 70. Furthermore, the pair of ridges 72 defines a lens space 74 between the pair of ridges to receive an edge 76 of a respective lens 54.

A pair of second clamps 78 is provided and each second clamp 78 of the pair of second clamps 78 is movably integrated into a respective eyewire 14 of the eyeglasses 12. Each second clamp 78 of the pair of second clamps 78 is compressible inwardly on the respective eyewire 14 and each second clamp 78 of the pair of second clamps 78 is positioned opposite a respective first clamp 50 in the respective eyewire 14. Furthermore, each second clamp 78 of the pair of second clamps 78 is located in the lens opening 52 defined by the respective eyewire 14 to compress against a respective lens 54 that is inserted into the lens opening 52 defined by the respective eyewire 14 for retaining the respective lens 54 in the lens opening 52 defined by the respective eyewire 14. The second outward member 30 of each eyewire 14 of the pair of eyewires 14 has an inwardly facing surface 80 of the second outward member 30. Additionally, each second clamp 78 of the pair of second clamps 78 is disposed on the inwardly facing surface 80 of the second outward member 30 of a respective eyewire 14.

Each the each second clamp 78 of the pair of second clamps 78 comprises a plurality of second biasing members 82 coupled to and extending laterally away from the inwardly facing surface 80 of the second outward member 30 of a respective eyewire 14. The plurality of second biasing members 82 is evenly spaced apart from each other and is distributed between the top member 32 and the bottom member 34 of the respective eyewire 14. Additionally, each second biasing member 82 of the plurality of second biasing members 82 has a distal end 84 with respect to the inwardly facing surface 80 of the second outward member 30. Each second biasing member 82 of the plurality of second biasing members 82 is biased to elongate between the inwardly facing surface 80 of the second outward member 30 and the distal end 84 of the second biasing members 82. Conversely, each second biasing member 82 of the plurality of second biasing members 82 is compressible between the distal end 84 of the second biasing members 82 and the inwardly facing surface 80 of the second outward member 30.

Each second clamp 78 of the pair of second clamps 78 includes a second panel 86 that has a first sidelong surface 88 and a second sidelong surface 90 and a forward edge 92 and a rear edge 94. The distal end 84 of each second biasing member 82 of the plurality of second biasing members 82 is coupled to the second sidelong surface 90. Additionally, the second panel 86 associated with a respective second clamp 78 is oriented to extend partially between the top member 32 and the bottom member 34 of the respective eyewire 14. The second panel 86 has a pair of ridges 96 of the second panel 86 each extending away from the first sidelong surface 88 and each ridge 96 of the pair of ridges 96 on the second panel 86 is aligned with and is coextensive with a respective one of the forward edge 92 and the rear edge 94. Furthermore, the pair of ridges 96 on the second panel 86 define a lens space 98 between the pair of ridges 96 on the second panel 86 to receive the edge 76 of a respective lens 54.

A pair of handles 100 is each coupled to a respective one of the pair of second clamps 78. Furthermore, each of the handles 100 can be manipulated by the user 20 to urge the pair of second clamps 78 inwardly on the respective eyewire 14 to make room for the lens 54 to be positioned between a respective first clamp 50 and a respective second clamp 78. The top member 32 of each eyewire 14 of the pair of eyewires 14 has a slot 102 extending through the top member 32. The slot 102 extends from the first outward member 28 of a respective eyewire 14 toward the second outward member 30 of the respective eyewire 14.

A respective handle 100 is coupled to and extends upwardly from the second lateral surface 66 of the first panel 62 of the respective first clamp 50 and a respective handle 100 is coupled to and extends upwardly from the second sidelong surface 90 of the second panel 86 of the respective second clamp 78. Each handle 100 of the pair of handles 100 extends upwardly through the slot 102 in the top member 32 of a respective eyewire 14. Consequently, each handle 100 of the pair of handles 100 can be gripped by the user 20.

A pair of springs 104 is provided and each spring 104 of the pair of springs 104 is positioned in the slot 102 in the top member 32 of a respective eyewire 14. The slot 102 has a lateral bounding surface 106 and each spring 104 of the pair of springs 104 is positioned between a respective handle 100 and the lateral bounding surface 106 of the slot 102 in the top member 32 the respective eyewire 14. Furthermore, each spring 104 of the pair of springs 104 biases the respective handle 100 to travel away from the first outward member 28 of the respective eyewire 14. The lens 54 may be a prescription lens from an old pair of eyeglasses 12, for example, or other type of prescription lens that the user 20 wishes to continue to employ without having to purchase a new eyeglasses frame.

In use, a respective handle 100 is gripped and is slid in the slot 102 in the top member 32 of a respective eyewire 14 to compress the respective second clamp 78 until the lens 54 can fit into the lens opening 52 in the respective eyewire 14. The respective handle 100 is released and the respective second clamp 78 is biased to compress the lens 54 between the respective second clamp 78 and a respective first clamp 50. Furthermore, the respective first clamp 50 and the respective second clamp 78 retain the lens 54 in the lens opening 52 in the respective eyewire 14. The lock 78 on the second portion 26 of a respective temple 16 is depressed to extend the second portion 26 of the respective temple 16 to the desired length and the lock 78 is released to secure the second portion 26 of the respective temple 16 at the desired length.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A replaceable lens eyeglasses device comprising:
a pair of eyeglasses having a pair of eyewires and a pair of temples wherein said pair of eyeglasses is configured to be worn on a head of a user having each eyewire of said pair of eyewires being positioned in front of a respective eye of the user, each temple of said pair of temples comprising a first portion which slidably receives a second portion such that each temple of said pair of temples has a telescopically adjustable length wherein said pair of eyeglasses is configured to fit a variety of sizes of users;
a pair of first clamps, each first clamp of said pair of first clamps being movably integrated into a respective eyewire of said eyeglasses, each first clamp of said pair of first clamps being compressible inwardly on said respective eyewire, each first clamp of said pair of first clamps being located in a lens opening defined by said respective eyewire wherein each first clamp of said pair of first clamps is configured to compress against a respective lens that is inserted into said lens opening defined by said respective eyewire;
a pair of second clamps, each second clamp of said pair of second clamps being movably integrated into a respective eyewire of said eyeglasses, each second clamp of said pair of second clamps being compressible inwardly on said respective eyewire, each second clamp of said pair of second clamps being positioned opposite a respective first clamp in said respective eyewire, each second clamp of said pair of second clamps being located in said lens opening defined by said respective eyewire wherein each second clamp of said pair of second clamps is configured to compress against a respective lens that is inserted into said lens opening defined by said respective eyewire for retaining the respective lens in the lens opening defined by said respective eyewire; and
a pair of handles, each handle of said pair of handles being coupled to a respective one of said pair of second clamps wherein each handle of said pair of handles is configured to be manipulated by the user to urge said pair of second clamps inwardly on said respective eyewire to make room for the lens to be positioned between a respective first clamp and a respective second clamp.

2. The replaceable lens eyeglasses device according to claim 1, further comprising:
each eyewire of said pair of eyewires comprising a first outward member and a second outward member each extending between a top member and a bottom member;
said second outward member of each eyewire of said pair of eyewires having a rear surface;
said first portion of each temple of said pair of temples having a coupled end and a free end;
said coupled end of said first portion of each temple of said pair of temples being hingedly coupled to said rear surface of a said second outward member of a respective eyewire;
said free end of said first portion of each temple of said pair of temples being open;
said second portion of each temple of said pair of temples having a front end; and
said free end of said first portion of a respective temple insertably receiving said front end of said second portion of said respective temple.

3. The replaceable lens eyeglasses device according to claim 1, further comprising:
each temple of said pair of temples having an inwardly facing side extending between said coupled end and said free end;
each temple of said pair of temples having a plurality of holes extending through said inwardly facing side;
said plurality of holes in a respective temple being centrally located between said coupled end and said free end of said respective temple; and
said plurality of holes in a respective temple being evenly spaced apart from each other and being distributed along a line extending between said coupled end of said respective temple and said free end of said respective temple.

4. The replaceable lens eyeglasses device according to claim 3, further comprising:
a pair of locks;
each lock of said pair of locks being movably disposed on said second portion of a respective temple;
each lock of said pair of locks being biased to extend away from said second portion of said respective temple;
said each lock of said pair of locks being urgeable toward said second portion of said respective temple; and
each lock of said pair of locks extending through a respective one of said plurality of holes in said inwardly facing side of said first portion of a respective temple for retaining said second portion of said respective temple at a desired length of extension from said first portion of said respective temple.

5. The replaceable lens eyeglasses device according to claim 2, further comprising:
said first outward member of each eyewire of said pair of eyewires having an inwardly facing surface; and
each first clamp of said pair of first clamps being disposed on said inwardly facing surface of said first outward member of a respective eyewire.

6. The replaceable lens eyeglasses device according to claim 5, further comprising:
each first clamp of said pair of first clamps comprises a plurality of first biasing members;
each first biasing member of said plurality of first biasing members being coupled to and extending laterally away from said inwardly facing surface of said first outward member of a respective eyewire;
said plurality of first biasing members being evenly spaced apart from each other and being distributed between said top member and said bottom member of said respective eyewire; and
each first biasing member of said plurality of first biasing members having a distal end with respect to said inwardly facing surface.

7. The replaceable lens eyeglasses device according to claim 6, further comprising:
each first biasing member of said plurality of first biasing member being biased to elongate between said inwardly facing surface and said distal end; and
each first biasing member of said plurality of first biasing members being compressible between said distal end and said inwardly facing surface.

8. The replaceable lens eyeglasses device according to claim 6, further comprising:
each first clamp of said pair of first clamps comprises a first panel having a first lateral surface and a second lateral surface and a front edge and a back edge;
said distal end of each first biasing member of said plurality of first biasing members being coupled to said first lateral surface; and
said first panel associated with a respective first clamp being oriented to extend partially between said top member and said bottom member of said respective eyewire.

9. The replaceable lens eyeglasses device according to claim 8, further comprising:
said first panel having a pair of ridges each extending away from said first lateral surface;
each ridge of said pair of ridges being aligned with and being coextensive with a respective one of said front edge and said back edge; and
said pair of ridges defining a lens space between said pair of ridges wherein said lens space is configured to receive an edge of a respective lens.

10. The device according to claim 2, further comprising:
said second outward member of each eyewire of said pair of eyewires having an inwardly facing surface of said second outward member; and
each second clamp of said pair of second clamps being disposed on said inwardly facing surface of said second outward member of a respective eyewire.

11. The replaceable lens eyeglasses device according to claim 10, further comprising:
each said each second clamp of said pair of second clamps comprises a plurality of second biasing members;
each second biasing member of said plurality of second biasing members being coupled to and extending laterally away from said inwardly facing surface of said second outward member of a respective eyewire;
said plurality of second biasing members being evenly spaced apart from each other and being distributed between said top member and said bottom member of said respective eyewire; and
each second biasing member of said plurality of second biasing members having a distal end with respect to said inwardly facing surface of said second outward member.

12. The replaceable lens eyeglasses device according to claim 11, further comprising:
each second biasing member of said plurality of second biasing members being biased to elongate between said inwardly facing surface of said second outward member and said distal end of said second biasing members; and
each second biasing member of said plurality of second biasing members being compressible between said distal end of said second biasing members and said inwardly facing surface of said second outward member.

13. The replaceable lens eyeglasses device according to claim x, further comprising:
each second clamp of said pair of second clamps comprising a second panel having a first sidelong surface and a second sidelong surface and a forward edge and a rear edge;
said distal end of each second biasing member of said plurality of second biasing members being coupled to said second sidelong surface; and
said second panel associated with a respective second clamp being oriented to extend partially between said top member and said bottom member of said respective eyewire.

14. The replaceable lens eyeglasses device according to claim 13, further comprising:
said second panel having a pair of ridges each extending away from said first sidelong surface;
each ridge of said pair of ridges on said second panel being aligned with and being coextensive with a respective one of said forward edge and said rear edge; and
said pair of ridges on said second panel defining a lens space between said pair of ridges on said second panel wherein said lens space defined on said second panel is configured to receive an edge of a respective lens.

15. The replaceable lens eyeglasses device according to claim 2, further comprising:
said top member of each eyewire of said pair of eyewires having a slot extending through said top member;
said slot extending from said first outward member of a respective eyewire toward said second outward member of said respective eyewire;
each first clamp of said pair of first clamps includes a first panel having a first lateral surface and a second lateral surface;
each second clamp of said pair of second clamps includes a second panel having a first sidelong surface and a second sidelong surface;
a respective handle being coupled to and extending upwardly from said second lateral surface of said first panel of said respective first clamp;
a respective handle being coupled to and extending upwardly from said second sidelong surface of said second panel of said respective second clamp; and
each handle of said pair of handles extending upwardly through said slot in said top member of a respective eyewire wherein each handle of said pair of handles is configured gripped by the user.

16. The replaceable lens eyeglasses device according to claim 2, further comprising:
said top member of each eyewire of said pair of eyewires having a slot extending through said top member;
a pair of springs;
each spring of said pair of springs being positioned in said slot in said top member of a respective eyewire;
said slot having a lateral bounding surface;
each spring of said pair of springs being positioned between a respective handle and said lateral bounding surface of said slot in said top member said respective eyewire; and
each spring of said pair of springs biasing said respective handle to travel away from said first outward member of said respective eyewire.

17. A replaceable lens eyeglasses device comprising:
a pair of eyeglasses having a pair of eyewires and a pair of temples wherein said pair of eyeglasses is configured to be worn on a head of a user having each eyewire of said pair of eyewires being positioned in front of a respective eye of the user, each temple of said pair of temples comprising a first portion which slidably receives a second portion such that each temple of said pair of temples has a telescopically adjustable length wherein said pair of eyeglasses is configured to fit a variety of sizes of users, each eyewire of said pair of eyewires comprising a first outward member and a second outward member each extending between a top member and a bottom member, said second outward member of each eyewire of said pair of eyewires having a rear surface, said first portion of each temple of said pair of temples having a coupled end and a free end, said coupled end of said first portion of each temple of said pair of temples being hingedly coupled to said rear surface of a said second outward member of a respective eyewire, said free end of said first portion of each temple of said pair of temples being open, each temple of said pair of temples having an inwardly facing side extending between said coupled end and said free end, each temple of said pair of temples having a plurality of holes extending through said inwardly facing side, said plurality of holes in a respective temple being centrally located between said coupled end and said free end of said respective temple, said plurality of holes in a respective temple being evenly spaced apart from each other and being distributed along a line extending between said coupled end of said respective temple and said free end of said respective temple, said second portion of each temple of said pair of temples having a front end, said free end of said first portion of a respective temple insertably receiving said front end of said second portion of said respective temple;
a pair of locks, each lock of said pair of locks being movably disposed on said second portion of a respective temple, each lock of said pair of locks being biased to extend away from said second portion of said respective temple, said each lock of said pair of locks being urgeable toward said second portion of said respective temple, each lock of said pair of locks extending through a respective one of said plurality of holes in said inwardly facing side of said first portion of a respective temple for retaining said second portion of said respective temple at a desired length of extension from said first portion of said respective temple;
a pair of first clamps, each first clamp of said pair of first clamps being movably integrated into a respective eyewire of said eyeglasses, each first clamp of said pair of first clamps being compressible inwardly on said respective eyewire, each first clamp of said pair of first clamps being located in a lens opening defined by said respective eyewire wherein each first clamp of said pair of first clamps is configured to compress against a respective lens that is inserted into said lens opening defined by said respective eyewire, said first outward member of each eyewire of said pair of eyewires having an inwardly facing surface, each first clamp of said pair of first clamps being disposed on said inwardly facing surface of said first outward member of a respective eyewire, each said each first clamp of said pair of first clamps comprising:
a plurality of first biasing members, each first biasing member of said plurality of first biasing members being coupled to and extending laterally away from said inwardly facing surface of said first outward member of a respective eyewire, said plurality of first biasing members being evenly spaced apart from each other and being distributed between said top member and said bottom member of said respective eyewire, each first biasing member of said plurality of first biasing members having a distal end with respect to said inwardly facing surface, each first biasing member of said plurality of first biasing members being biased to elongate between said inwardly facing surface and said distal end, each first biasing member of said plurality of first biasing members being compressible between said distal end and said inwardly facing surface; and
a first panel having a first lateral surface and a second lateral surface and a front edge and a back edge, said distal end of each first biasing member of said plurality of first biasing members being coupled to said first lateral surface, said first panel associated with a respective first clamp being oriented to extend partially between said top member and said bottom member of said respective eyewire, said first panel having a pair of ridges each extending away from said first lateral surface, each ridge of said pair of ridges being aligned with and being coextensive with a respective one of said front edge and said back edge, said pair of ridges defining a lens space between said pair of ridges wherein said lens space is configured to receive an edge of a respective lens;
a pair of second clamps, each second clamp of said pair of second clamps being movably integrated into a respective eyewire of said eyeglasses, each second clamp of said pair of second clamps being compressible inwardly on said respective eyewire, each second clamp of said pair of second clamps being positioned opposite a respective first clamp in said respective eyewire, each second clamp of said pair of second clamps being located in said lens opening defined by said respective eyewire wherein each second clamp of said pair of second clamps is configured to compress against a respective lens that is inserted into said lens opening defined by said respective eyewire for retaining the respective lens in the lens opening defined by said respective eyewire, said second outward member of each eyewire of said pair of eyewires having an inwardly facing surface of said second outward member, each second clamp of said pair of second clamps being disposed on said inwardly facing surface of said second outward member of a respective eyewire, each said each second clamp of said pair of second clamps comprising:
a plurality of second biasing members, each second biasing member of said plurality of second biasing members being coupled to and extending laterally away from said inwardly facing surface of said second outward member of a respective eyewire, said plurality of second biasing members being evenly spaced apart from each other and being distributed between said top member and said bottom member of said respective eyewire, each second biasing member of said plurality of second biasing members having a distal end with respect to said inwardly facing surface of said second outward member, each second biasing member of said plurality of second biasing members being biased to elongate between said inwardly facing surface of said second outward member and said distal end of said second biasing members, each second biasing member of said plurality of second biasing members being compressible between said distal end of said second biasing members and said inwardly facing surface of said second outward member; and
a second panel having a first sidelong surface and a second sidelong surface and a forward edge and a rear edge, said distal end of each second biasing member of said plurality of second biasing members being coupled to said second sidelong surface, said second panel associated with a respective second clamp being oriented to extend partially between said top member and said bottom member of said respective eyewire, said second panel having a pair of ridges each extending away from said first sidelong surface, each ridge of said pair of ridges on said second panel being aligned with and being coextensive with a respective one of said forward edge and said rear edge, said pair of ridges on said second panel defining a lens space between said pair of ridges on said second panel wherein said lens space defined on said second panel is configured to receive an edge of a respective lens;
a pair of handles, each handle of said pair of handles being coupled to a respective one of said pair of second clamps wherein each handle of said pair of handles is configured to be manipulated by the user to urge said pair of second clamps inwardly on said respective eyewire to make room for the lens to be positioned between a respective first clamp and a respective second clamp, said top member of each eyewire of said pair of eyewires having a slot extending through said top member, said slot extending from said first outward member of a respective eyewire toward said second outward member of said respective eyewire, a respective handle being coupled to and extending upwardly from said second lateral surface of said first panel of said respective first clamp, a respective handle being coupled to and extending upwardly from said second sidelong surface of said second panel of said respective second clamp, each handle of said pair of handles extending upwardly through said slot in said top member of a respective eyewire wherein each handle of said pair of handles is configured gripped by the user; and
a pair of springs, each spring of said pair of springs being positioned in said slot in said top member of a respective eyewire, said slot having a lateral bounding surface, each spring of said pair of springs being positioned between a respective handle and said lateral bounding surface of said slot in said top member said respective eyewire, each spring of said pair of springs biasing said respective handle to travel away from said first outward member of said respective eyewire.
